(19) United States
(12) Patent Application Publication
(10) Pub. No.: US 2007/0019047 A1
(43) Pub. Date: Jan. 25, 2007

(54) Ink cartridge

(75) Inventors: Markus Kleinert, Marburg (DE); Reinhard Maier, Zeilaru (DE); Matias Nagl, Eisenarzt (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KMP Printtechnik AG

(21) Appl. No.: 11/367,906

(22) Filed: Mar. 3, 2006

Related U.S. Application Data
(63) Continuation of application No. PCT/EP04/10076, filed on Sep. 9, 2004.

(30) Foreign Application Priority Data
Sep. 10, 2003 (DE) 103 41787.7

(51) Int. Cl. B41J 2/175

(52) U.S. Cl. 347/86

(57) ABSTRACT

An ink cartridge 1 for a print head 2, comprising a container 3 having a lid 4 and a bottom 5, the lid having at least one opening 6,16, the bottom having an outlet 7 and the container forming an ink reservoir 8. A porous and compressible element 9 is positioned in the ink reservoir and has a first holding capacity and a first flow resistance for ink. A barrier 10 completely covers the element 9, and the barrier has a second holding capacity and a second flow resistance for ink. In at least some regions, the second holding capacity is lower than the first holding capacity of the element 9, or the second flow resistance is greater than the first flow resistance of element 9. The barrier is positioned in the container in such a way that it contacts the lid and prevents contact between the element and the lid. The ink cartridge is characterized by a simple construction and improved printing quality over its operating life.

### CROSS REFERENCE TO RELATED APPLICATION

The present application is a continuation of International Application No. PCT/EP2004/010076, filed Sep. 9, 2004, and which designates the United States. The disclosure of the referenced application is incorporated herein by reference.

### BACKGROUND OF THE INVENTION

The present invention relates to an ink cartridge which can be fitted to a print head, preferably a print head for an inkjet printer. The ink cartridge comprises a container having container walls, a lid and a bottom, the lid or at least one of the container walls having at least one opening, the bottom having an outlet, and the container forming at least one ink reservoir. Provided in the at least one ink reservoir is at least one porous and compressible element, which is capable of storing ink and discharging it again in response to pressure.

Such an ink container emerges, for example, from the German patent application bearing the file reference DE 34 86 486 T2. There, in order to reliably supply the necessary quantity of ink without excess ink or a deficiency of ink, it is proposed to provide at least one ink-holding means in the container. This ink-holding means has pores which become progressively smaller in a direction toward the ink supply connection. The effect of this is that the capillary forces become gradually greater along the path of the ink, the intention being for the ink concentration to be increased in the direction of the ink supply connection. Because of the progressive discharge of ink, it may be necessary to provide pressure equalization. For this purpose, the ink container has an air hole in order to connect the interior of the ink container to the surrounding atmosphere.

Now, it is necessary to take account of the fact that ink cartridges of this type and the printers comprising them are frequently subjected to vibrations, or temperature or pressure fluctuations. It is precisely with regard to the increasingly mobile configuration of computer accessories that this occurs increasingly nowadays. However, there is thus the risk that the stored ink will emerge through the openings in the container and soil the printer or the immediate surroundings.

In addition, the ink located at or in the vicinity of the air hole can thicken or dry out completely as a result of a loss of liquid and possibly close the air hole without this being noticed, in particular in the case of a long standing time of a printer and in a warm climate. However, the consequence of this would be that the ink cartridge no longer delivers the desired quantity of ink to a print head. In order to avoid this, it is proposed in the prior art, in the region of the ventilation opening, to provide an ink-holding means located in the ink container with a cut-out, for example, or, in another way, by means of suitable mechanical measures, for example by means of spacers fitted on the wall or the lid of the ink container in the region of a ventilation opening, to produce a spacing between a ventilation opening and ink-holding means.

With regard to the drying out of the ink in the region of the ventilation opening, the proposed solutions known from the prior art are unsatisfactory, however, since, as a rule, the drying out of the ink in the region of the ventilation opening is not prevented or not prevented to an adequate extent. As a result, for example in the case of renewed filling of the ink container, color differences can result. Furthermore, dried ink residues can be transported in the direction of the ink supply connector and in this way possibly block up the print head or the feed lines to the print head. As a consequence, either the ink container or the print head or both becomes unserviceable and, in the worst case, has to the replaced.

On this basis, it is an objective of the present invention to solve the problems associated with the prior art. Furthermore, the intention in particular is to propose an ink cartridge which ensures a long lifetime, a low tendency of soiling the printer and a continuous ink flow. Furthermore, the construction is to be simple and operationally reliable. Since such articles are mass-produced products, attention is also to be paid to cost-effective production suitable for fabrication.

The above objectives and others are achieved by various embodiments of the ink cartridge of the present invention. It should be pointed out here that the features described in various embodiments of the present invention indicate further advantageous refinements of the ink cartridge, on their own or in any desired combination with one another.

### SUMMARY OF THE INVENTION

One embodiment of the present invention provides an ink cartridge for a print head, comprising a container having container walls, a lid, and a bottom, the lid or at least one container wall having at least one opening, the bottom having an outlet and the container forming at least one ink reservoir, at least one first porous and compressible element in the at least one ink reservoir, the at least one first element having a first holding capacity and a first flow resistance for ink, at least one barrier, which has a second holding capacity and a second flow resistance for ink, wherein at least in some regions, at least the second holding capacity is lower than the first holding capacity of the at least one first element, or the second flow resistance being greater than the first flow resistance of the at least one first element, wherein the barrier is positioned in the container in such a way that, at least in some regions, it presses against a container wall having an opening or the lid having an opening and, at least in some regions, prevents contact between the at least one element and the container wall having an opening or the lid having an opening.

It should be pointed out that the container of the ink cartridge can be constructed in one part or else in many parts, for example in order to hold only one type of ink or to hold two or more different types of ink, in particular to hold black and colored ink. In particular, it is possible that the lid represents a component of the ink cartridge which can easily be removed by the user and which, if appropriate, is also additionally fixed to the container with adhesive means or bonding means.

The material recommended for such a container is plastic, since this is particularly lightweight and robust. In addition, this material permits production by injection molding, so that a large number of such containers can be produced at little cost.

As already explained, it is advantageous to provide the lid (or any other desired wall of the container) with an opening which permits pressure equalization between the ink reservoir and the external environment. Here, the provision of such an opening in the lid is now proposed in order to reduce the risk of the ink flowing out of the container. In this case, within the context of the present invention, the term “lid” is to be understood to designate a wall of the container which is subsequently connected to the container and which can substantially be located on any desired side of the container.

The bottom has an outlet (ink supply connector), which is the removal point for ink. Starting from this outlet, the ink is transported to the print head and ultimately to the paper to be printed. In other embodiments, it is also possible for a plurality of outlets to be provided, in particular in the case of ink cartridges which form more than one ink reservoir. In such embodiments, the container comprises dividing walls, for example, which form a plurality of ink reservoirs, for example for different colors. In such a case, it is advantageous if each ink reservoir is assigned at least one opening and at least one outlet.

Provided in the at least one ink reservoir is at least one first porous and compressible element, which has a first holding capacity and a first flow resistance for ink. In principle, any porous component which can be compressed in at least one spatial direction under the conditions prevailing in the ink cartridge is suitable as a porous and compressible element. In principle, within the context of the present invention, all materials which, on account of their structure, are suitable to hold and to store ink and to discharge the ink under suitable conditions are suitable as porous and compressible elements. Furthermore, suitable porous and compressible elements are distinguished by the fact that, at least locally, the pore size of the compressible element can be varied by compression. For example, within the context of the present invention, felts or sponges are used as porous compressible elements. Sponges made of polymer materials are preferably used as porous and compressible elements, for example made of suitable polyurethanes, polyethers or polyesters and the like. The use of molded foam bodies, whose shape corresponds substantially to the contour of the ink reservoir, is particularly preferred.

The pore size of suitable porous and compressible elements is, for example, about 10 pores per inch to about 200 pores per inch, in particular 60 ppi to about 100 pores per inch. Suitable foams have, for example, a density of 20 to about 200 kg/m³, in particular about 40 to about 100 kg/m³, in particular about 50 to about 70 kg/m³.

“Holding capacity” is understood as the quantity of ink which the element can hold in a unit volume. In order to determine the holding capacity of the compressible element, a cube (edge length 1 cm) of this element in the uncompressed state is brought into contact with ink until saturated, atmospheric pressure and room temperature characterizing the ambient conditions, and the quantity of ink which is stored in the interior of the element is determined gravimetrically.

“Flow resistance” is to be understood as the tendency of the element to hinder the flow of ink through its interior. The flow resistance can be determined, for example, by ink being applied to a surface of the element and it being determined what pressure is needed for ink to penetrate forward into the internal regions of the element. In this case, the flow resistance directly on the surface of the element is of particular interest.

In addition, the ink cartridge according to the invention comprises at least one second element as a barrier, which has a second holding capacity and a second flow resistance for ink, at least in some regions at least the second holding capacity being lower than the first holding capacity of the at least one element, or the second flow resistance being greater than the first flow resistance of the at least one element, or the second holding capacity being lower than the first holding capacity of the at least one element and the second flow resistance being greater than the first flow resistance of the at least one element. The term “barrier” is therefore not necessarily to be interpreted as meaning that the passage of ink through this barrier is impossible. However, a “barrier” as used in the sense of the invention presents at least an increased resistance to the ink passage to the first compressible element.

In other words, this means in particular that the second compressible element, as compared with the first porous compressible element, can hold less ink, at least in one region, and/or has a higher flow resistance for ink. This increased flow resistance as compared with the element or the lower holding capacity is preferably present over virtually the entire volume or the entire surface of the barrier. In particular, at least 80% of the surface of the barrier has an increased flow resistance as compared with the first element. Preferred is the configuration of the second compressible element as a barrier which is only slightly permeable to ink, its holding capacity in the entire volume being lower than that of the porous and compressible element.

According to the invention, this barrier is positioned in the container in such a way that, at least in some regions, it contacts one wall or the lid which has the ventilation opening and, at least in some regions but preferably substantially completely, prevents contact between the at least one second compressible element and the wall or the lid. In principle, it is of course also possible to use a plurality of such barriers, this applying both to the container as such and to one ink reservoir in each case. The provision of a plurality of barriers can in this case be such that the barriers at least partly overlap and/or adjoin one another directly. The barriers can assume virtually any desired shape and preferably match the contour of the at least one first element and/or the lid. The barrier preferably likewise consists of a polymer material, in particular of an open-cell or closed-cell foam, for example of polyethylene, polybutadiene, neoprene, polyurethane, polyethers or polyesters and the like. In this case, the barrier has in particular a lower compressibility and, if the barrier consists of a foam, a smaller pore size. The pore size of a suitable barrier preferably lies in the range from 80 to 1%, for example in a range from 70 to 5% or 60 to 10% or 50 to 20% or 40 to 30% of the pore size of the first porous and compressible element. A closed-cell foam (foam with closed pores) is preferably used as a barrier.

With regard to the position of the barrier in the container, it should be pointed out that the barrier does not have to completely contact the lid; also suitable is a configuration in which the barrier contacts only partly, for example on ribs, transverse struts or other components starting from the lid and projecting into the ink reservoir. At the same time, however, the barrier prevents any contact between the at least one element and the lid (if the latter has at least one ventilation opening) or, in general, at least that container wall which has at least one ventilation opening. This ensures, for example, that the stored ink does not flow toward the air hole or the at least one opening in the lid or in a container wall. The first porous and compressible element is also prevented from adhering directly to the lid on account of dried-on ink. The consequence of this would be that the provision of a desired quantity of ink at the outlet cannot be ensured. According to the invention, improved printing quality over the operating period of the ink cartridge is accordingly achieved in a simple way. In addition, it is necessary to take account of the fact that, because of its configuration with ribs or the like and without the barrier proposed here, the lid would form a large number of cavities with the element, it being possible for ink to be deposited and dry there again and again. This would lead firstly to particulate contaminants being present in the ink reservoir and, under certain circumstances, hindering a desired flow of ink toward the outlet. In addition, the dried-on ink is lost to the user, that is to say it cannot be used for printing, and the user has to insert a new cartridge or refill the empty ink cartridge after a shorter or reduced printing activity. These negative effects above do not occur when the barrier according to the invention is used in the ink cartridge.

According to another embodiment of the ink cartridge, the barrier completely covers a surface of the at least one first porous and compressible element facing the lid bearing at least one ventilation opening or a container wall bearing at least one ventilation opening. In other words, this means that the barrier is fitted to the surface of the at least one element in such a way that it reaches over at least the surface of the latter facing the lid, provided that the lid has the ventilation opening. Under certain circumstances, it is also advantageous to provide the barrier with a larger area than the surface of the element, so that subregions of the barrier project beyond the surface and, if appropriate, extend at least partly over side surfaces of the at least one element. In this connection, a barrier which is formed in one piece is very particularly preferred.

Furthermore, it is proposed that the barrier have at least one section adjacent to the at least one opening of the lid, this section having a third flow resistance for ink which is lower than the second flow resistance. In particular, this section has a flow resistance for ink which is also lower than the first flow resistance of the porous compressible element. In other words, this means that the section, which in particular represents a local area which is considerably smaller than the surface of the barrier, can easily be penetrated by ink or ink supply devices.

This applies in particular to openings which are used for the purpose of supplying ink to the at least one ink reservoir from outside through the lid. This section can already have this property before the ink cartridge is filled, but it is also possible for this property to occur only after the ink cartridge has been filled. The latter is the case, for example, if the at least one barrier is damaged during the filling process or is destroyed in some sections. For instance, it is possible to provide the barrier with a perforation, a supply connector which is pushed through an opening during the filling operation dividing the barrier, at least partly, close to the perforation. Advantageously, however, no material cut-outs are provided so that, when the filling tool is pulled out, the cracks produced substantially close again or the adjacent subregions of the barrier lie so close to one another again that the first compressible element containing ink is substantially sealed off with respect to the ventilation opening.

In this connection, it is particularly advantageous that the section comprises at least one passage, preferably a slit-like or cross-slit-like passage. Passages of this type are in particular perforations or slits. They ensure on the one hand that the ink supplied penetrates the barrier in this closely limited, local section, at least for the filling operation. On the other hand, they are nevertheless configured in such a way that contact between the porous compressible element and the lid is prevented. With regard to the slit-like configuration of the passages, “X”-shaped embodiments are preferably suitable, since these form or at least partly bound reclosable flap sections which substantially close again after the filling operation.

According to another embodiment, the at least one barrier is connected to the at least one element by a form fit. This ensures that the same relative position of the barrier in relation to the at least one element is maintained over the entire operating period of the ink cartridge. In this regard, it is possible for the at least one barrier to extend over the entire surface of the element and to project beyond the latter, so that a collar engaging around the element is formed, at least in some regions. Another possible way of providing the form fit can be effected by the barrier and the first compressible element interengaging at the surface of the element itself.

In this connection, it is particularly advantageous that the at least one barrier has at least one projection which extends into a cut-out in the at least one element. First of all, it should be pointed out that, in principle, all known types of what are known as mortise and tenon systems or similar arrangements can be used to make a form fit between barrier and element. However, the barrier preferably has a locally limited elevation or a projection, which is oriented toward the element, since in this way the barrier can be thin-walled and thus less space is needed for the component, which is less suitable with regard to the storage of ink. The projection can in this case have any desired shape, the cut-out having approximately a corresponding shape.

According to a further refinement, it is proposed that the at least one first compressible element be compressed adjacent to the at least one barrier, on account of the form fit. This can be effected, for example, by the cut-out of the at least one element having a lesser extent (in the uncompressed state) than the projection from the barrier. This means that the cut-out of the element is widened when the two parts are joined together and force-fit connection of barrier and element also takes place. On account of the compressibility and porosity of the element and of the pressure exerted on the element by the projection of the barrier, the material of the element close to this cut-out is compressed. This means, for example, that after the components have been joined together, the pore size of the element in the region of the cut-out or close to the surface of the element is smaller than in other regions of the element. In particular in the case in which the most uniform compression possible is to be provided close to the entire surface of the element, it is also proposed to provide a plurality of projections and cut-outs, which each effect local compression close to the surface of the element. As compared with conventional systems, this refinement has the advantage that, during the filling operation, the ink is already drawn in the direction of the center of the container during the filling as a result of the compression occurring close to the surface in the preferably longitudinal direction of the ink container and the associated increase in the capillary forces in this region, which eases the filling operation. In addition, the ink is transported away from the ventilation opening.

As a result of another embodiment, a first opening of the lid is formed as an ink supply for filling the ink container, and a second opening as an air inlet, the first opening having a collar which extends toward the at least one element and which is in contact at least with the at least one barrier, while the second opening is arranged at a distance from the at least one barrier, so that an air gap is formed.

With regard to the ink supply, explanations have already been given above, to which reference is made here. In addition, it should be noted that the collar can be used, for example, as a guide means for a supply connector or a needle or similar devices for supplying ink toward the element. In addition, the collar possibly additionally fixes the at least one barrier on the surface of the element. The result of these two effects is that the ink supply connectors etc. can be conducted directly toward the section and, in this way, simple filling of the ink cartridge is ensured. The collar is preferably formed in one piece with the lid.

The function of the air inlet has also already been explained above. The formation of the air gap between the air inlet and the barrier is ensured, for example, by the collar or other recesses in the lid, such as ribs or the like. Thus, the air inlet cannot block and equalization between the ink reservoir and the surroundings is possible at any temperature or any ambient pressure. For the purpose of clarification, it should be pointed out that, of course, at least close to the air inlet, the barrier is permeable to air or other gaseous fluids.

Furthermore, it is also proposed that the outlet in the bottom form at least one chamber, in which at least one porous and compressible body is arranged. In relation to the configuration of the at least one porous and compressible body, reference is made to the entire extent of the German patent application bearing the file reference DE 102 50 610, which does not form a prior publication, so that the explanations there can be used for the description or supplementary explanation of the present text. With regard to the properties of such a porous and compressible body, reference should be made at this point to the explanations with regard to the porous and compressible element, in particular in relation to the compressibility and the pore size.

The porous and compressible body can be configured substantially freely, as a rule matching the contour of the outlet. However, it is conceivable that the body has an external cross section of rectangular, square, round or substantially circular form, while the chamber in the outlet has a form differing from this. It is not necessary for the body to be located completely in the chamber; instead, it is also possible for part of the body to project out of the chamber and into the ink reservoir.

Finally, it is also proposed that the outlet have means for sealing off an outlet opening. Sealing means are to be understood both as means which close the outlet completely (e.g. for the time until the cartridge is inserted into the print head), and also means which prevent the ink running out of the ink reservoir or the ink cartridge during the operation of the ink cartridge. In this regard, too, reference is made to the entire disclosure of the German patent application bearing the file reference DE 102 50 610, which does not form a prior publication.

In one embodiment of the ink cartridge, a projection extending toward the at least one element is arranged on the at least one opening in order to form a ventilation duct. With the aid of the projection, the first element and the barrier are kept at a distance directly in front of the opening, so that the opening remains free. The projection provides a sufficiently large cavity directly in front of the opening, that is to say in a region having a diameter of one to three times the diameter of the opening, which effectively prevents the ink emerging by means of its barrier effect. By means of the projection, cut-outs or punched-out portions on the barrier and the first element are rendered superfluous. By means of the projection, the element and the barrier are advantageously forced away from the opening, which means that a cavity having a barrier effect is produced.

In a further advantageous embodiment of the invention, the projection is formed as a spacer, in particular a collar, having at least one lateral ventilation duct. The ventilation duct can be formed by at least one slit or at least one ventilation opening. Here, too, the element or a barrier formed as a covering sponge does not have to be punched out since, at the ventilation opening, the air can flow between the tines formed by the slit and through the filling opening between the barrier and the element and the lid. During filling, the barrier or the element is pierced by the needle. During evacuation, although the barrier or the element bears on the filling opening, it is not sealed off. Air can flow, for example, between the tines formed by a plurality of slits in the spacer, in particular the collar.

A second subject of the present invention relates to an ink cartridge for a print head, which has a container having container walls and a lid and a bottom, the lid or at least one container wall having at least one opening, the bottom having an outlet and the container forming at least one ink reservoir, and comprises at least one first porous and compressible element in the at least one ink reservoir, a projection extending toward the at least one element being arranged on the at least one opening in order to form a ventilation duct.

Here, too, with the aid of the projection, the first element or the barrier is held at a distance directly in front of the opening, so that the opening remains free. The projection provides a sufficiently large cavity directly in front of the opening, that is to say in a region having a diameter of one to three times the diameter of the opening, which effectively prevents the ink emerging by means of its barrier effect. By means of the projection, cut-outs or punched-out portions in or on the barrier and in or on first element are rendered superfluous. By means of the projection, the element and the barrier are advantageously forced away from the opening, which means that the element and the barrier are compressed and a cavity having a barrier effect is produced.

As already described, it is advantageous to form the projection as a spacer, in particular a collar, having at least one lateral ventilation duct, in particular to form the ventilation duct by means of at least one slit or at least one ventilation opening in the spacer, in particular the collar. Lateral means that the ventilation duct is arranged transversely with respect to the direction with which the spacer, in particular the collar, reaches into the interior of the ink cartridge. In particular, the lateral arrangement ensures that the ventilation duct is not sealed off by the barrier or the element.

It is advantageous to arrange the projection on the opening in relation to the barrier or the element in such a way that the at least one element or the barrier can be compressed. By means of this compression, a cavity is created in front of the opening and develops a barrier action since here, as opposed to the interior of the element or the barrier, no capillary forces act.

### BRIEF DESCRIPTION OF THE DRAWINGS

Having thus described the invention in general terms, reference will now be made to the accompanying drawings, which are not necessarily drawn to scale, and wherein:

FIG. 1 shows a first embodiment of an ink cartridge according to the invention, perspectively and in a cross section;

FIG. 2 shows a first exemplary embodiment of a barrier, schematically and perspectively;

FIG. 3 shows schematically the formation of a form fit between a barrier and a porous compressible element;

FIG. 4 shows a further embodiment of the ink cartridge according to the invention in operation, schematically and in a cross section;

FIG. 5 shows schematically a second exemplary embodiment of a barrier;

FIG. 6 shows perspectively a first variant of a lid for a second embodiment of an ink cartridge according to the invention; and

FIG. 7 shows perspectively a second variant of a lid for a second embodiment of an ink cartridge according to the invention.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

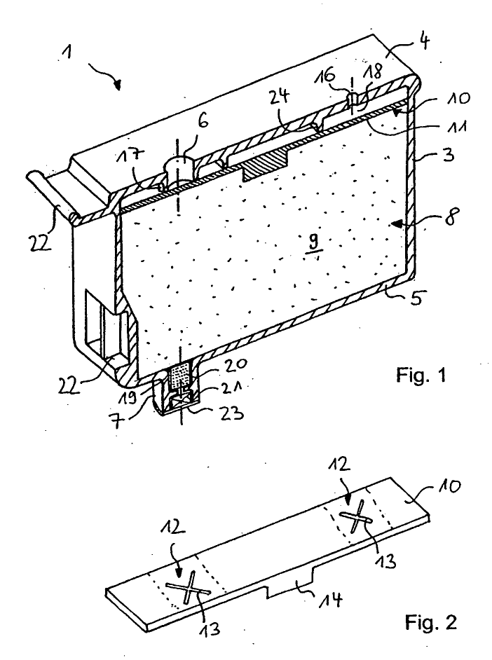

FIG. 1, shows a cross section through one embodiment of the ink cartridge 1 according to the invention, schematically and perspectively. The ink cartridge 1 comprises a container 3 having a lid 4 and a bottom 5, the lid 4 having two openings 6, 16. The bottom 5 has an outlet 7, and the container 3 likewise forms an ink reservoir 8. In this case, the first opening 6 is formed as an ink supply and the second opening 16 as an air inlet. As can be gathered from FIG. 1, the first opening 6 has a collar 17 extending into the interior of the ink reservoir 8 and a plurality of ribs 24. The collar 17 and the ribs 24 ensure that an air gap 18 is formed in the interior of the ink reservoir 8 close to the second opening 16, which forms the air inlet. The container 3 is additionally provided with holders 22, which permit the insertion of the ink cartridge 1 into inkjet printers, for example. The holders 22 are as a rule type-dependent and can be configured as desired in accordance with the necessary conditions.

Furthermore, the ink cartridge 1 has a porous compressible element 9 in the ink reservoir 8. This has a first holding capacity and a first flow resistance for ink. This is a felt or preferably a foam molding, which is substantially matched to the shape of the ink reservoir 8, the shapes of the ink reservoir 8 and of the element 9 (in the uncompressed state) substantially corresponding.

Also provided is a barrier 10, which has a second holding capacity and a second flow resistance for ink. In one embodiment, the barrier 10 has a lower holding capacity and a higher flow resistance for ink as compared with the element 9. In the embodiment illustrated, the barrier 10 is pressed by the collar 17 and by the ribs 24 onto a surface 11 of the element 9, which is completely covered by the barrier 10. At the same time, an air gap 18 is formed in the vicinity of the second opening 16 by the barrier 10 and the container 3.

The barrier 10 is positioned in the container 3 in such a way that it contacts the lid 4 and prevents contact between the at least one element 9 and the lid 4. In the illustrated embodiment, the barrier 10 completely covers the surface 11 of the element 9 facing the lid 4.

The bottom 5 has an outlet 7, which forms a chamber 19. Arranged in this chamber 19 is a porous and compressible body 20. The outlet 7 is sealed off with respect to the environment by a closure 23, this closure 23 being at least partly destroyed or damaged when the ink cartridge 1 is put into operation. Between the body 20 and the closure 23, further means are provided for sealing off an outlet opening 21 and, particularly during the operation of the ink cartridge 1, prevent ink flowing out of the outlet 7 when this is not desired.

FIG. 2 shows an exemplary embodiment of a barrier 10, schematically and in a perspective illustration. With regard to its dimensions, the barrier 10 substantially corresponds to the surface 11 of the element 9 and has two sections 12 which are arranged adjacent to the two openings 6, 16 of the lid. Each section 12 has passages 13 configured in the shape of slits. In principle, it is possible for such a section 12 to be arranged only close to the ink supply opening 6 but, from the point of view of fabrication, it is expedient under certain circumstances to configure the construction of the barrier 10 symmetrically. On the one hand, the flexibility of use of the barrier 10 is increased; on the other hand, mounting errors are also prevented. For the exact alignment and positioning of the barrier 10 with respect to the element 9 and/or the first opening 6 of the lid 4 as an ink supply, a projection 14 is provided, which can be inserted into the element 9 with a form fit.

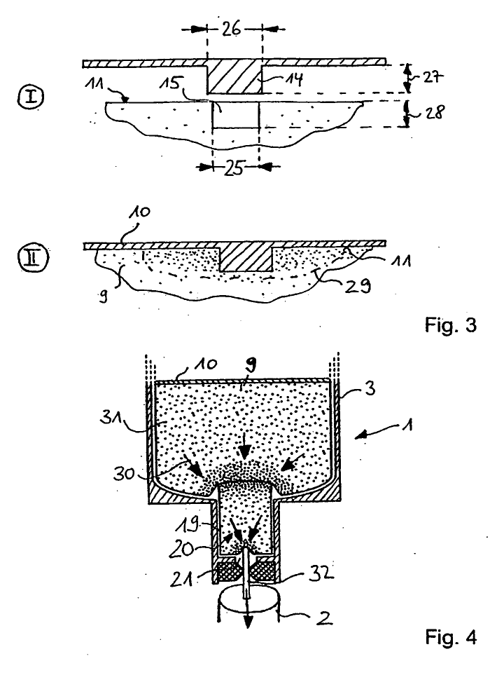

The formation of such a form fit is illustrated schematically in FIG. 3. In the partial view I, the barrier 10 and the element 9 are illustrated in a position spaced apart from each other. As this figure reveals, the barrier 10 has a projection 14 which has a second extent 26 and a height 27. Opposite, the element 9 is illustrated with a cut-out 15, the cut-out 15 extending into inner regions of the element 9, starting from a surface 11, and having a first extent 25 and a depth 28. In the illustration, it can be seen that the projection 14 is larger than the cut-out 15; in particular the second width 26 of the projection 14 is larger than the first width 25 of the cut-out 15. The second extent is preferably at least 10% larger.

Under certain circumstances, it is also advantageous to configure the height 27 of the projection 14 and the depth 28 of the cut-out 15 differently, but this is not necessarily the case. In order to produce a good form-fitting and force-fitting seat of the barrier 10 on or in the element 9, the height 27 should be designed to be larger than the depth 28.

The partial view II, which shows the assembled state of the barrier 10 and element 9, reveals how compression of the element 9 takes place as a result of the form fit. This is illustrated by the points lying closer together, which represent the pores 31 of the element 9. The barrier 10, which preferably has a higher dimensional stability than the element 9, widens the cut-out 15. This leads to compression or compaction of the material of the element 9 close to the surface 11 and in a region 29 around the cut-out 15.

FIG. 4 shows another embodiment of the ink cartridge 1 in operation, schematically and in a cross section. In this case, the ink cartridge 1 has been placed on an ink supply needle 32 of a print head 2. As a result of fitting the ink cartridge 1 onto the ink supply needle 32, the porous body 20 is firstly compressed on its underside facing the ink supply needle 32 and secondly, as a result of the pressure exerted by the ink supply needle 32, is pushed in the direction of the ink reservoir 8 and the element 9. In the process, a pressure contact is built up between the porous body 20 in the outlet 7 and the porous element 9 of the ink reservoir 8. As a result, the porous element 9, which is more compressible than the porous body 20, is compressed. As a result of the reduction in size of the pores 31 in the respectively compressed regions of the porous body 20 and of the porous element 9, a preferred ink flow 30 (indicated by arrows) from the ink reservoir 8 toward the ink supply needle 32 is effected. The ink supply needle is normally brought into contact with the body 20 only when an ink flow toward the print head 2 is desired. Otherwise, the ink supply needle 32 is drawn back into the print head 2, means being provided for sealing off the outlet opening 21 for precisely this time period. Sealing means of this type can be sealing rings, for example, these possibly having a hole arranged at the center for the ink supply needle 32 to be led through and bearing on the latter.

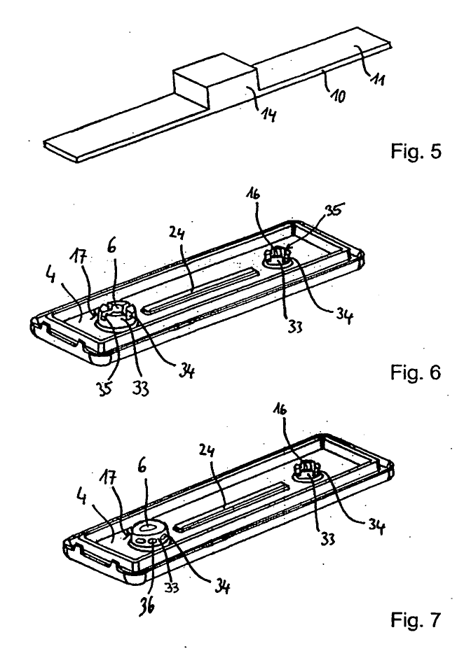

FIG. 5 shows schematically another exemplary embodiment of a barrier which has no cut-outs or punched-out portions for a second embodiment of an ink cartridge 1 according to the invention. The second embodiment has, for example, a lid as described in FIGS. 6 and 7. FIG. 6 shows one variant of a lid perspectively, and FIG. 7 shows another variant of a lid perspectively. The lid according to FIGS. 6 and 7 has a projection 33 extending toward the at least one element 9 or toward the barrier 10 in order to form a ventilation duct 34. The projection 33 is configured as a spacer, in particular a collar 17, which has a plurality of lateral ventilation ducts 34. While in FIG. 6 the ventilation ducts 34 are formed by a plurality of slits 35, in FIG. 7 they are formed by a plurality of ventilation openings 36 of holes or drilled holes. The projection 33 is able to compress the element 9 or the barrier 10 in a region around the opening 6, 16, in particular a region having a diameter of one to three times the diameter of the opening 6, 16, so that a cavity is produced directly in front of the opening 6, 16, which develops a barrier action against an emergence of ink from the ink cartridge 1.

The ink cartridge proposed here is distinguished by simple production and improved printing quality over the operating period. Furthermore, the risk of the emergence of ink is reduced considerably and the filling operation is eased considerably by the construction according to the invention.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An ink cartridge for a print head, comprising:
a container having container walls, a lid, and a bottom, the lid or at least one container wall having at least one opening, the bottom having an outlet, and the container forming at least one ink reservoir;
at least one first porous and compressible element in the at least one ink reservoir, the at least one first element having a first holding capacity and a first flow resistance for ink;
at least one compressible and porous barrier, which has a second holding capacity and a second flow resistance for ink, wherein at least in some regions, the second flow resistance is greater than the first flow resistance of the at least one first element; and
wherein the barrier is positioned in the container in such a way that, at least in some regions, it contacts the container wall or the lid and, at least in some regions, prevents contact between the at least one element and the container wall or the lid.

2. The ink cartridge of claim 1, wherein the at least one barrier completely covers a surface of the at least one element facing the lid.

3. The ink cartridge of claim 1, wherein the at least one barrier has a section adjacent to at least one opening of the lid, the section having a third flow resistance for ink which is lower than the second flow resistance.

4. The ink cartridge of claim 3, wherein the section has at least one passage.

5. The ink cartridge of claim 4, wherein the passage is a slit-like passage.

6. The ink cartridge of claim 1, wherein the at least one barrier is connected to the at least one element with a form fit.

7. The ink cartridge of claim 6, wherein the at least one barrier has at least one projection which extends into a cut-out of the at least one element.

8. The ink cartridge of claim 6, wherein the at least one element is compressed adjacent to the at least one barrier on account of the form fit.

9. The ink cartridge of claim 1, wherein a first opening of the lid is an ink supply and a second opening is an air inlet, the first opening having a collar which extends toward the at least one element and which is in contact at least with the at least one barrier, while the second opening is arranged at a distance from the at least one barrier, so that an air gap is formed.

10. The ink cartridge of claim 1, wherein the outlet in the bottom forms at least one chamber, in which at least one porous and compressible body is arranged.

11. The ink cartridge of claim 1, wherein the outlet is structured to seal off an outlet opening.

12. The ink cartridge of claim 1, wherein a projection extending toward the at least one element is arranged at the at least one opening in order to form a ventilation duct.

13. The ink cartridge of claim 12, wherein the projection is formed as a spacer having at least one lateral ventilation duct.

14. The ink cartridge of claim 13, wherein the spacer is a collar.

15. The ink cartridge of claim 13, wherein the ventilation duct is formed by at least one slit or at least one ventilation opening.
